(19) United States
(12) Patent Application Publication
(10) Pub. No.: US 2020/0407500 A1
(43) Pub. Date: Dec. 31, 2020

(54) Flame retardant soft ether foams

(71) Applicant: COVESTRO DEUTSCHLAND AG, Leverkusen (DE)

(72) Inventors: Bert Klesczewski, Köln (DE); Jörg Hofmann, Krefeld (DE); Hartmut Nefzger, Pulheim (DE)

(21) Appl. No.: 16/084,001

(22) PCT Filed: Mar. 16, 2017
(86) PCT No.: PCT/EP2017/056279

§ 371 Date: Sep. 11, 2018

(30) Foreign Application Priority Data
Mar. 21, 2016 (EP) 16161347.6

(51) Int. Cl. C08G 65/26; C08G 18/48; C08G 18/50; C08G 18/76; C08G 18/24; C08L 71/02; C08L 75/08

(52) U.S. Cl. CPC C08G 65/2639; C08G 18/4829; C08G 18/4816; C08G 18/5084; C08G 2101/0008; C08G 18/244; C08G 65/2663; C08L 71/02; C08L 75/08; C08G 18/7621

(57) ABSTRACT

The present invention concerns a method for producing poly(oxyalkylene) polyols started with phosphorus-containing compounds, which have an inner block containing high amounts of EO, as well as the poly(oxyalkylene) polyols obtainable in this manner. Furthermore, the present invention comprises a method for producing polyurethane foams, preferably flexible polyurethane foams, by reacting an isocyanate component with a component reactive to isocyanates, which comprises at least one poly(oxyalkylene) polyol started with phosphorus-containing compounds with an inner block containing high amounts of EO, the polyurethane foams produced by the inventive method and their application.

### CROSS-REFERENCE TO RELATED APPLICATIONS

This application is a national stage application under 35 U.S.C. § 371 of PCT/EP2017/056279, filed Mar. 16, 2017, which claims the benefit of European Application No. 16161347.6, filed Mar. 21, 2016, both of which are being incorporated by reference herein.

### FIELD

The present invention concerns a method for producing poly(oxyalkylene) polyols started with phosphorus-containing compounds, which have an inner block containing high amounts of EO, as well as the poly(oxyalkylene) polyols obtainable in this manner. Furthermore, the present invention comprises a method for producing polyurethane foams, preferably flexible polyurethane foams, by reacting an isocyanate component with a component reactive to isocyanates, which comprises at least one poly(oxyalkylene) polyol started with phosphorus-containing compounds with an inner block containing high amounts of EO, the polyurethane foams produced by the inventive method and their application.

### BACKGROUND

To increase the fire safety of foams, the standard method is to add a flame retardant when producing the foams. However, added flame retardants often cause problems in the foaming as well as regarding emissions.

There is a desire, therefore, on the part of the foam-producing industry, to obtain flexible foams which meet the relevant fire safety standards (e.g. FMVSS 302) without also having to use flame retardants.

### SUMMARY

Surprisingly, this task was resolved by using special poly(oxyalkylene) polyols started with phosphorus-containing acids comprising an inner block containing high amounts of EO when producing the foams. These poly(oxyalkylene) polyols are obtained by a special method.

Thus, the subject matter of the invention is a method for producing poly(oxyalkylene) polyols, wherein initially in a first step
A) i) at least one phosphorus-containing compound with at least one hydroxyl group, or
   ii) a mixture of at least one phosphorus-containing compound having at least one hydroxyl group with at least one H-functional starter compound, are reacted with
B) an alkaline oxide component, comprising:
   i) ≥50 to ≤100% w/w of ethylene oxide and
   ii) ≥0 to ≤50% w/w of other alkylene oxides such as ethylene oxide,

and the product obtained from the first step is then reacted, using DMC catalysis, with
C) an alkylene oxide component, comprising:
   i) ≥0 to ≤25% w/w of ethylene oxide and
   ii) ≥75 to ≤100% w/w of other alkylene oxides such as ethylene oxide and
D) if necessary, carbon dioxide.

Within the meaning of the invention, “H-functional” is understood to mean a starter compound having H atoms active in alkoxylation.

The subject matters of the present invention are, moreover, the poly(oxyalkylene) polyols obtainable from the inventive method.

### DETAILED DESCRIPTION

Within the meaning of the invention, “poly(oxyalkylene) polyols” are understood to mean polyether polyols and polyether carbonate polyols.

The 2-stage synthesis of polyols based on phosphorus-containing starter molecules is known from EP1751212A1. But the prior art does not mention any special epoxide compounds for the individual steps. Just pure propylene oxide is used in all examples, at least in the first step in each case.

Description of the inventive method:

### Method Step 1:

Compounds with at least one hydroxyl group (component A) i)) are used as phosphorus-containing compounds in the inventive method, said compounds having the following formula:

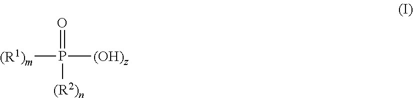

in which:

z=a whole number from 1 to 3,

n=0 or 1,

m=0 or 1 and

z+m+n=3.

R¹ and R² may be the same or differ from each other and stand for
i) —H
ii) —P(O)(OH)₂
iii) saturated or unsaturated, linear or branched, aliphatic or cycloaliphatic or if necessary, substituted aromatic or araliphatic residuals with up to 10 carbon atoms linked to the phosphorus via a C atom, which if necessary, contain heteroatoms from the series oxygen, sulphur and nitrogen, wherein linear or branched aliphatic residuals with up to 10 carbon atoms, containing if necessary, heteroatoms from the series oxygen, sulphur and nitrogen, are preferred,
iv) —OR³ or —OC(O)R⁴, wherein R³ or R⁴, respectively, stand for saturated or unsaturated, linear or branched, aliphatic or cycloaliphatic or if necessary, substituted aromatic or araliphatic residuals with up to 10 carbon atoms, containing if necessary, heteroatoms from the series oxygen, sulphur and nitrogen, and
   wherein linear or branched aliphatic residuals with up to 10 carbon atoms, containing if necessary, heteroatoms from the series oxygen, sulphur and nitrogen, are preferred.

Furthermore, oligomers and/or polymers of any of the aforementioned compounds having at least one hydroxyl group and obtainable by condensation and having at least one hydroxyl group can be used as starter compounds in the inventive method. However, condensates of just one compound can be involved as well as mixed condensates. The oligomers or polymers can have linear, branched or ring-shaped structures.

The following compounds are quoted as examples: phosphoric acid, phosphonic acid (phosphorous acids), phosphinic acid, pyrophosphoric acid (diphosphoric acid), diphosphonic acid, polyphosphoric- and polyphosphonic acids, such as triphosphoric acid or -phosphonic acid, tetrapolyphosphoric acid or -phosphonic acid, tri- or tetrametaphosphoric acid, hypodiphosphoric acid, esters of any of these compounds and/or other oligomers or polymers of these compounds.

The phosphorus-containing compounds described can be used individually as well as in mixtures.

Preferably, the phosphorus-containing compounds have at least 2 OH groups.

Preferably, phosphoric acid, phosphonic acid, pyrophosphoric acid (diphosphoric acid), diphosphonic acid, triphosphoric acid, triphosphonic acid, tetrapolyphosphoric acid, tetrapolyphosphonic acid, tri- and/or tetrametaphosphoric acid is used as a starter, and, particularly phosphoric acid.

These compounds can be used mixed with water. Such mixtures fall under component A) ii), which is described later.

Preferably, 100 percent phosphoric acid (component A) i)) or 85 percent phosphoric acid (component A) ii)) is used.

Other starter compounds can be added to the phosphorus-containing compounds (A) ii)). In doing so, the H-functional compounds involved have an average H-functionality from ≥1 to ≤6, preferably from ≥1 and ≤4, particularly preferably ≥2 and ≤3. Within the meaning of the invention, “H-functional” is understood to mean a starter compound which has H atoms active in alkoxylation.

Suitable H-functional starter compounds which can be used are compounds with H atoms active for the alkoxylation. Examples of groups with active H atoms that are active for the alkoxylation include, for example, —OH, —NH₂ (primary amines), —NH— (secondary amines), —SH and —CO₂H, preferably —OH and —NH₂, particularly preferably —OH. One or more compounds is/are used as an H-functional starter substance, selected for example from the group consisting of water, mono- or polyvalent alcohols, polyvalent amines, polyvalent thiols, amino alcohols, thio alcohols, hydroxyesters, polyether polyols, polyester polyols, polyester ether polyols, polyether carbonate polyols, polycarbonate polyols, polycarbonates, polyethylene imines, polyether amines (e.g. so-called Jeffamine® by Huntsman, such as D-230, D-400, D-2000, T-403, T-3000, T-5000 or corresponding products from BASF, such as polyether amine D230, D400, D200, T403, T5000), polytetrahydrofurans (e.g. PolyTHF® from BASF, such as PolyTHF® 250, 650S, 1000, 10005, 1400, 1800, 2000), polytetrahydrofuran amines (BASF product polytetrahydrofuran amine 1700), polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing, on the average, at least 2 OH groups per molecule. In the case, for example, of the C₁-C₂₄ alkyl fatty acid esters, containing, on the average, at least 2 OH groups per molecule, these can be in the form of commercial products such as Lupranol Balance® (BASF AG), Merginol® types (Hobum Oleochemicals GmbH), Sovermol® types (Cognis Deutschland GmbH & Co. KG) and Soyol®™ types (USSC Co.).

Alcohols, amines, thiols and carboxylic acids can be used as monofunctional starter compounds. The following may be used as monofunctional alcohols: methanol, ethanol, 1-propanol, 2-propanol, 1-butanol, 2-butanol, t-butanol, 3-buten-1-ol, 3-butin-1-ol, 2-methyl-3-buten-2-ol, 2-methyl-3-butin-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Monofunctional amines that can be considered are: butylamine, t-butylamine, pentylamine, hexylamine, aniline, aziridine, pyrrolidine, piperidine, morpholine. Monofunctional thiols that can be used are: ethanethiol, 1-propanethiol, 2-propanethiol, 1-butanethiol, 3-methyl-1-butanethiol, 2-butene-1-thiol, thiophenol. Monofunctional carboxylic acids might be mentioned: formic acid, acetic acid, propionic acid, butyric acid, fatty acids such as stearic acid, palmitic acid, oleic acid, linoleic acid, linolenic acid, benzoic acid, acrylic acid.

Examples of polyvalent alcohols suitable as H-functional starter compounds include bivalent alcohols (examples of which are ethylene glycol, diethylene glycol, propylene glycol, dipropylene glycol, 1,3-propanediol, 1,4-butanediol, 1,4-butenediol, 1,4-butinediol, neopentyl glycol, 1,5-pentanediol, methylpentanediols (such as 3-methyl-1,5-pentanediol), 1,6-hexanediol; 1,8-octanediol, 1,10-decanediol, 1,12-dodecanediol, bis-(hydroxymethyl)-cyclohexanes (such as 1,4-bis-(hydroxymethyl)cyclohexane), triethylene glycol, tetraethylene glycol, polyethylene glycols, dipropylene glycol, tripropylene glycol, polypropylene glycole, dibutylene glycol and polybutylene glycols); trivalent alcohols (such as trimethylolpropane, glycerine, tris hydroxyethyl isocyanurate, castor oil); quadrivalent alcohols (such as pentaerythritol); poly alcohols (such as sorbitol, hexitol, sucrose, starch, starch hydrolysate, cellulose, cellulose hydrolysate, hydroxy-functional fats and oils, particularly castor oil), as well as all modifying products of these alcohols mentioned above, with different amounts of ε-caprolactone. In mixtures of H-functional starter compounds, trivalent alcohols, such as trimethylolpropane, glycerine, tris hydroxyethyl isocyanurate and castor oil can also be used.

The H-functional starter compounds can also be selected from the substance class of the polyether polyols, particularly those with a molecular weight Mₙ in the range from 100 to 4000 g/mol, preferably 250 to 2000 g/mol. Polyether polyols are preferably constructed of repeating ethylene oxide- and propylene oxide units, preferably with a proportion of 35 to 100% of propylene oxide units, particularly preferably, with a proportion of 50 to 100% of propylene oxide units. This can involve statistical copolymers, gradient copolymers, alternating or block copolymers of ethylene oxide and propylene oxide. Suitable polyether polyols, constructed of repeating propylene oxide- and/or ethylene oxide units are, for example, Desmophen®-, Acclaim®-, Arcol®-, Baycoll®-, Bayfill®-, Bayflex®-, Baygal®-, PET®- and polyether polyols from Bayer MaterialScience AG (such as Desmophen® 3600Z, Desmophen® 1900U, Acclaim® polyol 2200, Acclaim® polyol 40001, Arcol® polyol 1004, Arcol® polyol 1010, Arcol® polyol 1030, Arcol® polyol 1070, Baycoll® BD 1110, Bayfill® VPPU 0789, Baygal® K55, PET® 1004, Polyether® S180). Examples of other suitable homo-polyethylene oxides include the Pluriol® E-brands from BASF SE, suitable homo-polypropylene oxides include, for example, the Pluriol® P-brands from BASF SE, suitable mixed copolymers of ethylene oxide and propylene oxide are, for example, the Pluronic® PE or Pluriol® RPE-brands from BASF SE.

The H-functional starter compounds can also be selected from the substance class of the polyester polyols, particularly those with a molecular weight Mₙ in the range from 200 to 4500 g/mol, preferably 400 to 2500 g/mol. At least difunctional polyesters are used as polyester polyols. Preferably, polyester polyols consist of alternating acid- and alcohol units. Acidic components that can be used are, for example, bernstein acid, maleic acid, maleic acid anhydride, adipinic acid, phthalic acid anhydride, phthalic acid, isophthalic acid, terephthalic acid, tetrahydrophthalic acid, tetrahydrophthalic acid anhydride, hexahydrophthalic acid anhydride or mixtures of the listed acids and/or anhydrides. Alcohol components that can be used are, for example, ethanediol, 1,2-propanediol, 1,3-propanediol, 1,4-butanediol, 1,5-pentanediol, neopentyl glycol, 1,6-hexanediol, 1,4-bis-(hydroxymethyl)-cyclohexane, diethylene glycol, dipropylene glycol, trimethylolpropane, glycerine, pentaerythritol or mixtures of the listed alcohols. If divalent or polyvalent polyether polyols are used as alcohol components, polyester-ether polyols are obtained which can also serve as starter substances to produce the poly(oxyalkylene) polyols. If polyether polyols are used to produce the polyester-ether polyols, polyether polyols with a number average molecular weight Mₙ from 150 to 2000 g/mol are preferred.

Furthermore, polycarbonate polyols (such as polycarbonate diols) can be used as H-functional starter compounds, particularly those with a molecular weight Mₙ in the range from 150 to 4500 g/mol, preferably 500 to 2500, which are produced, for example, by the reaction of phosgene, dimethyl carbonate, diethyl carbonate or diphenyl carbonate and di- and/or polyfunctional alcohols or polyester polyols or polyether polyols. Examples involving polycarbonate polyols can be found, for example, in EP-A 1359177. For example, the Desmophen® C-types from Bayer MaterialScience AG can be used as polycarbonate diols, such as Desmophen® C. 1100 or Desmophen® C. 2200. Also, polyether carbonate polyols can be used as H-functional starter compounds.

Preferred H-functional starter compounds are water and alcohols with the general formula (ii),

HO—(CH₂)ₓ—OH (ii)

wherein x is a number from 1 to 20, preferably, an even number from 2 to 20. Examples for alcohols per formula (ii) are ethylene glycol, 1,4-butanediol, 1,6-hexanediol, 1,8-octanediol, 1,10 decanediol and 1,12-dodecanediol. Further preferable H-functional starter substances are neopentyl glycol, trimethylolpropane, glycerine, pentaerythritol, reaction products of the alcohols per formula (ii) with ε-caprolactone, such as reaction products of trimethylolpropane with ε-caprolactone, reaction products of glycerine with ε-caprolactone, and reaction products of pentaerythritol with ε-caprolactone. Other substances preferably used as H-functional starter compounds are water, diethylene glycol, dipropylene glycol, castor oil, sorbitol and polyether polyols, constructed from repeating polyalkylene oxide units.

Particularly preferably, the H-functional starter compounds involve one or more compounds selected from the group consisting of water, ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerine, trimethylolpropane, di- and trifunctional polyether polyols, wherein the polyether polyol is constructed from a di- or tri-H-functional starter compound(s) and propylene oxide or a di- or tri-H-functional starter compound(s), propylene oxide and ethylene oxide. The polyether polyols preferably have a number average molecular weight Mₙ in the range from 62 to 4500 g/mol and particularly a number average molecular weight Mₙ in the range from 62 to 3000 g/mol, quite particularly preferably, a molecular weight from 62 to 1500 g/mol. Preferably, the polyether polyols have a functionality from ≥2 to ≤3.

If the phosphorus-containing compounds are used in mixture with H-functional starter compounds, the proportion of the H-functional starter compounds in the mixture is max. 50% w/w, preferably max. 30% w/w.

As described earlier already, preferably phosphoric acid is used as a phosphorus-containing compound. Particularly preferably, it is used as 100 percent phosphoric acid (component A) i)) or mixed with water as 85 percent phosphoric acid (component A) ii)).

If 85% phosphoric acid is used, it is preferable to mix it with at least one other H-functional starter compound. Preferably, this other H-functional starter compound is an alcohol.

According to the inventive method, the starter compound or, as the case may be, mixture (A) is reacted in a first step with
B) an alkylene oxide component, comprising:
   i) ≥50 to ≤100% w/w of ethylene oxide and
   ii) ≥0 to ≤50% w/w of another alkylene oxide such as ethylene oxide.

Preferably, pure ethylene oxide is reacted with the starter compound or the starter mixture.

If a mixture of ethylene oxide with other alkylene oxides is used, the mixture contains ≥50% w/w, preferably, ≥80% w/w, particularly preferably, ≥90% w/w of ethylene oxide.

Alkylene oxides (epoxides) used in mixture with the ethylene oxide are those with 3 to 24 carbon atoms. The alkylene oxides with 3 to 24 carbon atoms involve, for example, one or more compounds selected from the group consisting of propylene oxide, 1-butene oxide, 2,3-butene oxide, 2-methyl-1,2-propene oxide(isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidised fats as mono-, di- and triglycerides, epoxidised fatty acids, C₁-C₂₄ esters of epoxidised fatty acids, epichlorhydrin, glycidol, and derivates of the glycidols, such as methyl glycidyl ether, ethyl glycidyl ether, 2-ethyl hexyl glycidyl ether, allyl glycidyl ether, glycidyl methacrylate and epoxy-functional alkoxysilanes, such as 3-glycidyloxypropyltrimethoxysilane, 3-glycidyloxypropyltriethoxysilane, 3-glycidyloxypropyltripropoxysilane, 3-glycidyloxypropyl-methyl-dimethoxysilane, 3-glycidyl-oxypropylethyldiethoxysilane, 3-glycidyloxypropyltrlispropoxysilane. Preferably, propylene oxide and/or 1,2 butylene oxide, particularly preferably, propylene oxide in mixture with the ethylene oxide are used.

In a preferable embodiment B) comprises
i) ≥50 to ≤100% w/w of ethylene oxide and
ii) ≥0 to ≤50% w/w of other alkylene oxides such as ethylene oxide, preferably propylene oxide and/or 1,2 butylene oxide, particularly preferably propylene oxide.

In a particularly preferable embodiment, B) comprises
i) ≥80 to ≤100% w/w of ethylene oxide and
ii) ≥0 to ≤20% w/w of other alkylene oxides such as ethylene oxide, preferably propylene oxide and/or 1,2 butylene oxide, particularly preferably propylene oxide.

In a quite particularly preferable embodiment B) comprises
i) ≥90 to ≤100% w/w of ethylene oxide and
ii) ≥0 to ≤10% w/w of other alkylene oxides such as ethylene oxide, preferably propylene oxide and/or 1,2 butylene oxide, particularly preferably propylene oxide.

In an even more preferable embodiment, B) comprises
100% w/w of ethylene oxide.

In the reaction of the phosphorus-containing starter or, respectively, the mixture of phosphorus-containing and H-functional starter compounds (A) with the alkylene oxide component (B), the molar ratio of component (B) to hydroxyl groups of component (A) is 1 to 8:1, preferably 2 to 5:1.

Method step 1 can be performed in the presence or in the absence of a catalyst catalysing the alkoxylation reaction. Preferably method step 1 is carried out without a catalyst.

DMC catalysts cannot be used in method step 1.

The catalysts possibly used in method step 1 involve, in particular, acids or lewis acid catalysts, such as BF₃, BF₃ etherate, SbF₅, PF₅, yttrium- or aluminium triflate, HBF₄, trifluormethanesulfonic acid or perchloric acid.

Method step 1 can be carried out in the presence or in the absence of an inert solvent. Examples of suitable solvents include heptane, cyclohexane, toluene, xylene, diethylether, dimethoxyethane or chlorinated hydrocarbon, such as methylene chloride, chloroform or 1,2-dichlorpropane. The solvent, if used, is used, in the main, in an amount from 10 to 30% w/w in relation to the total amount of the reaction mixture.

Method step 1 is performed at temperatures from 0 to 200° C., preferably 20 to 180° C., particularly preferably 40 to 150° C.

### Method Step 2:

According to the inventive method, the product obtained with DMC catalysis from step 1 is reacted with
C) a alkylene oxide component, comprising
   i) ≥0 to ≤25% w/w of ethylene oxide and
   ii) ≥75 to ≤100% w/w of other alkylene oxides such as ethylene oxide.

Refer to the statements under method step 1 regarding the alkylene oxides to be used. Preferably, in component (C ii), propylene oxide and/or 1,2 butylene oxide, particularly preferably propylene oxide is used as “other alkylene oxides”.

Preferably ≥85% w/w, particularly preferably ≥90% w/w of other alkylene oxides such as ethylene oxide are used in (C ii).

In a preferable embodiment, C) comprises
i) ≥0 to ≤25% w/w of ethylene oxide and
ii) ≥75 to ≤100% w/w of other alkylene oxides such as ethylene oxide, preferably propylene oxide and/or 1,2 butylene oxide, particularly preferably propylene oxide.

In a particularly preferable embodiment, C) comprises
i) ≥0 to ≤15% w/w of ethylene oxide and
ii) ≥85 to ≤100% w/w of other alkylene oxides such as ethylene oxide, preferably propylene oxide and/or 1,2 butylene oxide, particularly preferably propylene oxide.

In a quite particularly preferable embodiment, C) comprises
i) ≥0 to ≤10% w/w of ethylene oxide and
ii) ≥90 to ≤100% w/w of other alkylene oxides such as ethylene oxide, preferably propylene oxide and/or 1,2 butylene oxide, particularly preferably propylene oxide.

In the reaction of the product from method step 1 with the alkylene oxide component (C) the molar ratio of component (C) to hydroxyl groups of the product from step 1 is 5 to 30:1, preferably 10 to 20:1.

The reaction of the product from method step 1 with (C) can take place in the presence of carbon dioxide (D) as co-monomer. In this case, the weight ratio of the alkylene oxide component (C) to carbon dioxide is preferably 49 to 2,3:1.

The polyether carbonate polyol produced preferably contains carbonate groups (“units originating from carbon dioxide”), calculated as CO₂, from ≥2,0 and ≤30.0% w/w, preferably from ≥5.0 and ≤28.0% w/w and particularly preferably from ≥10.0 and ≤25.0% w/w.

The reaction of the product from step 1 with component (C) and if necessary, carbon dioxide (D) is performed using double metal cyanide catalysts (DMC catalysts).

DMC catalysts are known in principle from the prior art for the homopolymerisation of epoxides (refer, for example, to U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO-A 97/40086, WO-A 98/16310 and WO-A 00/47649, have a very high activity level in the homopolymerisation of epoxides and enable polyether polyols and/or polyether carbonate polyols to be produced with very small concentrations of catalysts (25 ppm or less). A typical example of highly active DMC catalysts is described in EP-A 700 949 containing, besides a double metal cyanide compound (e.g. zinc hexacyanocobaltate (iii)) and an organic complex ligand (e.g. t.-butanol), a polyether with a number average molecular weight Mₙ greater than 500 g/mol.

The DMC catalyst is used mostly in an amount of ≤500 ppm, preferably in an amount from ≥10 to ≤200 ppm, particularly preferably in an amount from ≥15 to ≤150 ppm and especially in an amount from ≥20 to ≤120 ppm, each in relation to the weight of the polyether- or polyether carbonate polyol obtained from method step 2.

Each of the method steps 1 and/or 2 can be performed in the presence or absence of an inert solvent. Suitable solvents include, for example, heptane, cyclohexane, toluene, xylene, diethylether, dimethoxyethane or chlorinated hydrocarbon, such as methylene chloride, chloroform or 1,2-dichlorpropane. The solvent, insofar as it is used, is used, in the main, in an amount of 10 to 30% w/w in relation to the total amount of the reaction mixture.

Method step 2 can be performed in the presence or absence of an inert solvent. Suitable solvents include, for example, heptane, cyclohexane, toluene, xylene, diethylether, dimethoxyethane or chlorinated hydrocarbon, such as methylene chloride, chloroform or 1,2-dichlorpropane. The solvent, insofar as it is used, is used, in the main, in an amount of 10 to 30% w/w in relation to the total amount of the reaction mixture.

Method step 2 is performed at temperatures from 0 to 200° C., preferably 20 to 180° C., particularly preferably 40 to 160° C.

As described earlier, other subject matters of the present invention are the poly(oxyalkylene) polyols obtainable from the inventive method.

These have hydroxyl values under DIN 53240 from ≥20 mg KOH/g to ≤130 mg KOH/g, preferably from ≥26 g KOH/g to ≤90 mg KOH/g.

A subject matter of the present invention is also the application of the poly(oxyalkylene) polyols obtainable from the inventive method for producing polyurethane foams, preferably flexible polyurethane foams.

Furthermore, a subject matter of the present invention is a method for producing polyurethane foams, preferably flexible polyurethane foams, by a reaction of
component E containing at least one poly(oxyalkylene) polyol, obtainable by the method described above (component E1),
F if necessary,
   F1) catalysts and/or
   F2) auxiliary materials and additives,
G water and/or physical propellants,
with
H di and/or polyisocyanates,
wherein the production takes place at an index from ≥90 to ≤120.

Preferably, the poly(oxyalkylene) polyols used in this method (component E1) have hydroxyl values under DIN 53240 from ≥20 mg KOH/g to ≤130 mg KOH/g, preferably from ≥26 mg KOH/g to ≤90 mg KOH/g.

The preferable subject matter is a method for producing polyurethane foams, preferably flexible polyurethane foams, by reaction of
E1 ≥20 to ≤100 parts by weight, preferably ≥40 to ≤100 parts by weight of at least one poly(oxyalkylene) polyol, which is obtainable by the method described above and has hydroxyl values under DIN 53240 from ≥20 mg KOH/g to ≤130 mg KOH/g,
E2 ≤80 to ≥0 parts by weight, preferably from ≤60 to ≥0 parts by weight of at least one poly(oxyalkylene) polyol, which has hydroxyl values under DIN 53240 from ≥20 mg KOH/g to ≤130 mg KOH/g and does not fall under the definition of component E1,
E3 ≤50 to ≥0 parts by weight, in relation to the total of the parts by weight of the components E1 and E2, at least one compound having groups reactive with isocyanates, which does not fall under the definition of components E1 or E2,
F if necessary,
   F1) catalysts and/or
   F2) auxiliary materials and additives,
G water and/or physical propellants,
with
H di and/or polyisocyanates,

wherein the production takes place at an index from ≥90 to ≤120 and wherein the total of the parts by weight of E1+E2 in the composition produces 100 parts by weight.

Other subject matters are methods according to the two methods just described wherein, however, no further polyol components are contained in the composition in addition to the components E1, or, respectively, E1 to E3.

The components E1 to E3 each refer to “at least one” of the listed compounds. When several compounds of one component are used, the stated amount corresponds to the total of the parts by weight of the compounds.

### Component E2:

Component E2 comprises poly(oxyalkylene) polyols, which have hydroxyl values under DIN 53240 from ≥20 mg KOH/g to ≤130 mg KOH/g, preferably ≥26 mg KOH/g to ≤90 mg KOH/g and does not fall under the definition of component E1.

Analogous to component E1, these can be obtained by the addition of alkylene oxides or alkylene oxides and carbon dioxide to H-functional starter compounds.

In general, to produce component E2, alkylene oxides (epoxides) with 2 to 24 carbon atoms can be used. The alkylene oxides with 2 to 24 carbon atoms involve, for example, one or more compounds selected from the group consisting of ethylene oxide, propylene oxide, 1-butene oxide, 2,3-butene oxide, 2-methyl-1,2-propene oxide(isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidised fats as mono-, di- and triglycerides, epoxidised fatty acids, C₁-C₂₄ esters of epoxidised fatty acids, epichlorhydrin, glycidol, and derivates of the glycidols, such as methyl glycidyl ether, ethyl glycidyl ether, 2-ethyl hexyl glycidyl ether, allyl glycidyl ether, glycidyl methacrylate and epoxy-functional alkoxysilanes, such as 3-glycidyloxypropyltrimethoxysilane, 3-glycidyloxypropyltriethoxysilane, 3-glycidyloxypropyltripropoxysilane, 3-glycidyloxypropyl-methyl-dimethoxysilane, 3-glycidyl-oxypropylethyldiethoxysilane, 3-glycidyloxypropyltrlisopropoxysilane. Preferably, ethylene oxide and/or propylene oxide and/or 1,2 butylene oxide, particularly preferably ethylene oxide and/or propylene oxide are used as alkylene oxides.

The same compounds can be used as H-functional starter compounds as those described under component A, i.e. phosphorus-containing compounds as described for component A) i) and/or other H-functional starter compounds as described for component A) ii). The use of the H-functional starter compounds in component A is independent from the use of the H-functional starter compounds for producing component E2.

If phosphorus-containing compounds (E2.1) are used as starter compounds for producing component E2, those preferably used in this case are phosphoric acid, phosphonic acid, pyrophosphoric acid (diphosphoric acid), diphosphonic acid, triphosphoric acid, triphosphonic acid, tetra polyphosphoric acid, tetra polyphosphonic acid, tri- and/or tetra metaphosphoric acid. Particularly preferably, phosphoric acid, quite particularly preferably 100 percent phosphoric acid or 85 percent phosphoric acid is used.

If other H-functional starter compounds (E2.2) are used as starter compounds, these preferably involves alcohols with the general formula (ii),

HO—(CH₂)ₓ—OH (ii)

wherein x is a number from 1 to 20, preferably, an even number from 2 to 20. Examples for alcohols per formula (ii) are ethylene glycol, 1,4-butanediol, 1,6-hexanediol, 1,8-octanediol, 1,10 decanediol and 1,12-dodecanediol. Also preferable are neopentyl glycol, trimethylolpropane, glycerine, pentaerythritol, reaction products of the alcohols per formula (ii) with ε-caprolactone, such as reaction products of trimethylolpropane with ε-caprolactone, reaction products of glycerine with ε-caprolactone, and reaction products of pentaerythritol with ε-caprolactone. Also preferable are water, diethylene glycol, dipropylene glycol, castor oil, sorbitol and polyether polyols, constructed from repeating polyalkylene oxide units. Particularly preferably, one or more compounds are involved selected from the group consisting of ethylene glycol, propylene glycol, 1,3-propanediol, 1,3-butanediol, 1,4-butanediol, 1,5-pentanediol, 2-methylpropane-1,3-diol, neopentyl glycol, 1,6-hexanediol, diethylene glycol, dipropylene glycol, glycerine, trimethylolpropane, di- and trifunctional polyether polyols, wherein the polyether polyol is constructed from a di- or tri-H-functional starter compound(s) and propylene oxide or a di- or tri-H-functional starter compound(s), propylene oxide and ethylene oxide. The polyether polyols preferably have a number average molecular weight Mₙ in the range from 62 to 4500 g/mol and particularly a number average molecular weight Mₙ in the range from 62 to 3000 g/mol, quite particularly preferably, a molecular weight from 62 to 1500 g/mol. Preferably, the polyether polyols have a functionality from ≥2 to ≤3.

Mixtures of the phosphorus-containing compounds E2.1 can be used with other H-functional starter compounds E2.2.

Preferably, H-functional starter compounds E2.2 and no phosphorus-containing starter compounds E2.1 are used.

Thus, the subject matter of the present invention is also a method for producing polyurethane foams, preferably flexible polyurethane foams, in a reaction of
component E containing at least one poly(oxyalkylene) polyol, obtainable according to the method described at the beginning (component E1), as well as at least one poly(oxyalkylene) polyol which was produced not using phosphorus-containing compounds (component E2),
F if necessary,
   F1) catalysts and/or,
   F2) auxiliary materials and additives
G water and/or physical propellants,
with
H di and/or polyisocyanates,
wherein the production takes place at an index from ≥90 to ≤120.

Furthermore, a subject matter of the present invention a method for producing polyurethane foams, preferably flexible polyurethane foams, from a reaction of
E1 ≥20 to <100 parts by weight, preferably ≥40 to <100 parts by weight of at least one poly(oxyalkylene) polyol, which is obtainable by the method described above and has hydroxyl values under DIN 53240 from ≥20 mg KOH/g to ≤130 mg KOH/g,
E2 ≤80 to >0 parts by weight, preferably from ≤60 to >0 parts by weight of at least one poly(oxyalkylene) polyol, which has hydroxyl values under DIN 53240 from ≥20 mg KOH/g to ≤130 mg KOH/g and was produced not using phosphorus-containing compounds,
E3 ≤50 to ≥0 parts by weight, in relation to the total of the parts by weight of the component E1 and E2, at least one compound having groups reactive with isocyanates, which does not fall under the definition of components E1 or E2,
F if necessary,
   F1) catalysts and/or,
   F2) auxiliary materials and additives
G water and/or physical propellants,
with
H di and/or polyisocyanates,

wherein the production takes place at an index from ≥90 to ≤120 and wherein the total of the parts by weight of E1+E2 in the composition produces 100 parts by weight.

Furthermore, a subject matter of the present invention is a method for producing polyurethane foams, preferably flexible polyurethane foams, by a reaction of
E1 ≥20 to <100 parts by weight, preferably ≥40 to <100 parts by weight of at least one poly(oxyalkylene) polyol, which is obtainable by the method described above and has hydroxyl values under DIN 53240 from ≥20 mg KOH/g to ≤130 mg KOH/g,
E2 ≤80 to >0 parts by weight, preferably from ≤60 to >0 parts by weight of at least one poly(oxyalkylene) polyol, which has hydroxyl values under DIN 53240 from ≥20 mg KOH/g to ≤130 mg KOH/g and was produced not using phosphorus-containing compounds,
E3 ≤50 to ≥0 parts by weight, in relation to the total of the parts by weight of the components E1 and E2, at least one compound having groups reactive with isocyanates, which does not fall under the definition of components E1 or E2 and was produced not using phosphorus-containing compounds,
F if necessary,
   F1) catalysts and/or,
   F2) auxiliary materials and additives
G water and/or physical propellants,
with
H di and/or polyisocyanates,

wherein the production takes place at an index from ≥90 to ≤120 and wherein the total of the parts by weight of E1+E2 in the composition produces 100 parts by weight.

Other subject matters are methods according to the methods just described wherein, however, besides components E1 and E2, or E1 to E3, no other polyol components are contained in the composition.

### Component E3:

Component E3 comprises compounds having groups reactive with isocyanates, which do not fall under the definition of components E1 or E2.

These involve all polyhydroxy compounds known to an expert in the art which do not fall under the definition of components E1 or E2, and preferably have a mean OH functionality >1.5.

These can be, for example, low molecular diols (e.g. 1,2-ethanediol, 1,3- or 1,2-propanediol, 1,4-butanediol), triols (e.g. glycerine, trimethylolpropane) and tetraols (e.g. pentaerythritol), polyester polyols, polythioether polyols, polyacrylate polyols, polymer polyols, PHD polyols and PIPA polyols.
Polymer polyols are polyols, containing proportions of monomers of polymers obtained in solid form, obtained by radical polymerisation, such as styrene or acrylonitrile in a basic polyol, such as a polyether polyol and/or polyether carbonate polyol.
PHD (polyurea dispersion) polyols are produced, for example, by in situ polymerisation of an isocyanate or an isocyanate mixture with a diamine and/or hydrazine in a polyol, preferably a polyether polyol. Preferably, the PHD dispersion is produced by reacting an isocyanate mixture used from a mixture of 75 to 85% w/w 2,4-toluene diisocyanate (2,4-TDI) and 15 to 25% w/w 2,6-toluene diisocyanate (2,6-TDI) with a diamine and/or hydrazine in a polyether polyol, preferably a polyether polyol and/or polyether carbonate polyol, produced by alkoxylation of a trifunctional starter (such as glycerine and/or trimethylolpropane), in the case of the polyether carbonate polyol in the presence of carbon dioxide. Methods for producing PHD dispersions are described, for example, in U.S. Pat. Nos. 4,089,835 and 4,260,530.
the PIPA polyols involve polyether polyols and/or polyether carbonate polyols modified by polyisocyanate polyaddition with alkanolamines, preferably triethanolamine-modified, wherein the polyether(carbonate)polyol has a functionality of 2,5 to 4 and a hydroxyl value of ≥3 mg KOH/g to ≤112 mg KOH/g (molecular weight 500 to 18000). Preferably, the polyether polyol is “EO-capped”, i.e. the polyether polyol has terminal ethylene oxide groups. PIPA polyols are described in depth in GB 2 072 204 A, DE 31 03 757 A1 and U.S. Pat. No. 4,374,209 A.

Besides the polyols, compounds with amino groups and/or thiol groups and/or carboxyl groups can be used also as component E3 for example. In the main, these compounds have 2 to 8, preferably 2 to 4, hydrogen atoms reactive to isocyanates. For example, ethanolamine, diethanolamine and/or triethanolamine can be used. Other examples are described in EP-A 0 007 502, pp. 16-17.

### Component F

As component F, if necessary,
F1) catalysts and/or
F2) auxiliary materials and additives,

are used.

The following are used preferably as catalysts F1: aliphatic tertiary amines (for example trimethylamine, tetramethyl butanediamine, 3-dimethylaminopropylamine, n,n-bis(3-dimethyl aminopropyl)-n-isopropanolamine), cycloaliphatic tertiary amines (for example 1,4-diaza(2,2,2)bicyclooctane), aliphatic aminoethers (for example bis dimethylaminoethyl ether, 2-(2-dimethylaminoethoxy)ethanol and n,n,n-trimethyl-n-hydroxyethyl-bis aminoethylether), cycloaliphatic aminoethers (for example n-ethylmorpholine), aliphatic amidines, cycloaliphatic amidines, urea and derivates of the urea (for example aminoalkyl ureas, cf. for example EP-A 0 176 013, in particular (3-dimethylaminopropylamine)-urea).

Tin(ii) salts of carboxylic acids can also be used as catalysts, wherein, preferably, the respective underlying carboxylic acid has from 2 to 20 carbon atoms. Particularly preferable are the tin(ii)-salt of 2-ethylhexane acid (i.e. tin(ii)-(2-ethylhexanoate)), the tin(ii) salt of 2-butyloctane acid, the tin(ii) salt of 2-hexyldecane acid, the tin(ii) salt of neodecane acid, the tin(ii) salt of oleic acid, the tin(ii) salt of ricinoleic acid and tin(ii)laurate. Also tin(iv) compounds, such as dibutyltin oxide, dibutyltin dichloride, dibutyltin diacetate, dibutyltin dilaurate, dibutyltin maleate or dioctyltin diacetate can be used as catalysts. Naturally, all of the listed catalysts can also be used as mixtures.

As auxiliary materials and additives F2, the following are used preferably:
a) surfactant additives (tensides), such as emulsifiers and foam stabilisers,
b) one or more additives selected from the group consisting of reaction delayers (such as acidic reacting substances like hydrochloric acid or organic acid halides), cell regulators (such as paraffins or fatty alcohols or dimethyl polysiloxanes), pigments, dyes, flame retardants (such as tricresyl phosphate), stabilisers to counter aging and weathering effects, plasticisers, fungistatically and bacteriostatically acting substances, fillers (such as barium sulphate, kieselgur, blacking or whiting) and release agents.

These auxiliary materials and additives that may be used, if necessary, are described, for example, in EP-A 0 000 389, pp. 18-21. Other examples of auxiliary materials and additives that may be used according to the invention, if necessary, as well as details about ways to apply them and modes of action of these auxiliary materials and additives are described in the Kunststoff-Handbuch (Plastics Manual), Volume VII, published by G. Oertel, Carl-Hanser-Verlag, Munich, 3rd. edition, 1993, on pp. 104-127 for example.

### Component G

Water and/or physical propellants are used as component G. For a physical propellant, carbon dioxide and/or highly volatile organic substances, for example, are used as propellants. Preferably, water is used as component G.

### Component H

Suitable di- and/or polyisocyanates are aliphatic, cycloaliphatic, araliphatic, aromatic and heterocyclic polyisocyanates, such as those, for example, described by W. Siefken in Justus Liebigs Annalen der Chemie, 562, pp. 75 to 136, for example those with the formula (III)

Q(NCO)ₙ, (III)

in which

n=2 4, preferably 2-3,

and
Q indicates an aliphatic hydrocarbon residual with 2-18, preferably 6-10 C atoms, a cycloaliphatic hydrocarbon residual with 4-15, preferably 6-13 C atoms or a araliphatic hydrocarbon residual with 8-15, preferably 8-13 C atoms.

For example, polyisocyanates are involved such as those described in EP-A 0 007 502, pp. 7 8. Preferably, polyisocyanates which, as a rule, are technically easily obtainable, such as 2,4- and 2,6-toluene diisocyanate, as well as any mixtures of these isomers (“TDI”); polyphenyl polymethylene polyisocyanates, such as those produced by aniline formaldehyde condensation followed by phosgenation (“crude MDI”) and polyisocyanates having carbodiimide groups, urethane groups, allophanate groups, isocyanurate groups, urea groups or biuret groups (“modified polyisocyanates”), particularly those modified polyisocyanates derived from 2,4- and/or 2,6-toluene diisocyanate or from 4,4′- and/or 2,4′-diphenylmethane diisocyanate. Preferably, one or more compounds selected from the group consisting of 2,4- and 2,6-toluene diisocyanate, 4,4′- and 2,4′- and 2,2′-diphenylmethane diisocyanate and polyphenyl polymethylene polyisocyanate (“polynuclear MDI”) is/are used as polyisocyanate. Particularly preferably, 2,4- and/or 2,6-toluene diisocyanate is used.

In another embodiment of the inventive method, the isocyanate component B comprises a toluene diisocyanate isomer mixture of 55 to 90% w/w 2,4- and to 45% w/w 2,6-TDI.

In another embodiment of the inventive method, the isocyanate component D comprises 100% 2,4-toluene diisocyanate.

In one embodiment of the inventive method, the index is ≥90 to ≤120. Preferably, the index lies in a range from ≥100 to ≤115, particularly preferably ≥102 to ≤110. The index states the percentage ratio of the isocyanate amount actually used to the stoichiometric amount of the isocyanate groups, i.e. the (NCO) amount of isocyanate groups calculated for the reaction of the OH-equivalence.

Index=[isocyanate amount used):(isocyanate amount calculated)·100 (IV)

To produce the polyurethane foams, the reaction components are reacted in accordance with known process stages wherein mechanical devices are often used, e.g. such as those described in EP-A 355 000. Details about processing facilities which are worth considering in relation to the invention are described in the Kunststoff-Handbuch, Volume VII, published by Vieweg and Höchtlen, Carl-Hanser-Verlag, Munich 1993, e.g. on pp. 139 to 265.

The polyurethane foams appear preferably as flexible polyurethane foams and can be produced as shaped pieces or also as blocks of foam, preferably as blocks of foam. The subject matter of the invention are therefore a method for producing the polyurethane foams, the polyurethane foams produced by this method, the blocks of flexible polyurethane foams or flexible polyurethane foam shapes produced by this method, the application of the flexible polyurethane foams for producing shaped parts as well as the shaped parts themselves.

Examples of applications of the polyurethane foams, preferably flexible polyurethane foams, obtainable according to the invention are as follows: furniture upholstering, textile inserts, mattresses, car seats, head rests, arm rests, sponges, foam films for use in car parts, such as roof linings, door trim panels, seat cushions and structural elements.

The inventive flexible foams have a bulk density under DIN EN ISO 3386-1-98 in the range from ≥16 to ≤60 kg/m³, preferably ≥20 to ≤50 kg/m³, wherein the low bulk densities are obtained by using liquid CO₂.

### EXAMPLES

The present invention is explained by means of the following examples, but is not limited to them. They are:

### Raw Materials Used:

DMC catalyst: double metal cyanide catalyst, produced according to example 6 in WO-A 01/80994.
Phosphoric acid (100%), from Sigma-Aldrich
Arcol® 1108: trifunctional polyether polyol, OH number 48, Covestro AG, Leverkusen
Niax® Catalyst A-1: commercial product from Momentive Performance Materials GmbH, Leverkusen, bis[2-(n,n′-dimethylamino)ethyl]-based
Tegostab® B 8239, commercial product, Evonik Nutrition & Care GmbH, Essen
DABCO® T-9, commercial product from Air Products GmbH, Hamburg, tin-(2-ethylhexanoate)
Desmodur® T 80, mixture of 2,4′-toluene diisocyanate and 2,6′-toluene diisocyanate in the ratio 80/20, Covestro AG, Leverkusen

### Measuring Methods:

Experimentally-determined OH numbers were determined per DIN 53240 requirements.

Experimentally-determined acid values were determined per DIN 53402 requirements.

The viscosities were determined by means of a rotational viscosimeter (Physica MCR 51, mfr: Anton Paar) per DIN 53018 requirements.

The compression hardness and the bulk density of the foams were determined per DIN EN ISO 3386-1 requirements.

The fire behaviour was determined on 13 mm thick foam test bodies according to Federal Motor Vehicle Safety Standard 302.

### Example 1

### Method Step 1: Ethoxylation of Phosphoric Acid:

300.1 g (3.06 mol) of phosphoric acid (100%) were placed in a 2 l stainless steel reactor and heated while stirring to 55° C. After several exchanges between nitrogen and a vacuum between 0.1 and 3.0 bar (absolute), the pressure in the reactor was adjusted to 2.1 bar (absolute) using nitrogen. 1450 g (32.9 mol) of ethylene oxide were measured at a temperature of 55° C. at a rate of 200 g/hr. After a secondary reaction time of 3 hours, the reaction mixture was cooled to room temperature and removed from the reactor. Volatile components were distilled out at 90° C. under reduced pressure (approx. 10 mbar) within 30 minutes.

The product had an OH number of 308 mg KOH/g and an acid number of 0.08 mg KOH/g.

Method Step 2: DMC Catalysed Alkoxylation of the Product from Method Step 1:

268 g of the intermediate product from method step 1 and 0.15 g of DMC catalyst were placed in a 2 l stainless steel reactor and heated while stirring (800 rpm) to 130° C. After 45 minutes of nitrogen stripping at a reduced pressure (0.1 bar absolute), 25 g of propylene oxide were added to activate catalysis. After an induction phase of approx. 15 min, the remaining propylene oxide (1207 g) was added continuously to the reactor while stirring (800 rpm) at a temperature of 130° C. within 190 min, wherein the pressure rose to 4.45 bar (absolute) to the end of the addition. After a secondary reaction time of 60 min at 130° C., volatile compounds were distilled out at 90° C. at a reduced pressure (approx. 10 mbar) within 30 minutes. The end product was stabilised with 500 ppm of the antioxidant Irganox 1076.

Product properties:

OH number=47.3 mg KOH/g

Acid number=0.09 mg KOH/g

Viscosity (25° C.)=1825 mPas

### Example 2

### Method Step 1: Ethoxylation of Phosphoric Acid:

Method step 1 was performed in a manner analogous to method step 1 in example 1.

Method Step 2: DMC-Catalysed Alkoxylation of the Product from Method Step 1:

265 g of the intermediate product from method step 1 and 0.15 g of DMC catalyst were placed in a 2 l stainless steel reactor and heated while stirring (800 rpm) to 130° C. After 45 minutes of nitrogen stripping at a reduced pressure (0.1 bar absolute), 25 g of propylene oxide were added to activate catalysis. After an induction phase of approx. 15 min, a mixture of 1075 g of propylene oxide and 123 g of ethylene oxide was added continuously to the reactor while stirring (800 rpm) at a temperature of 130° C. within 155 min, wherein the pressure rose to 4.70 bar (absolute) to the end of the addition.

After a secondary reaction time of 90 min at 130° C., volatile compounds were distilled out at 90° C. and a reduced pressure (approx. 10 mbar) within 30 minutes. The end product was stabilised with 500 ppm of the antioxidant Irganox 1076.

### Product Properties:

OH number=47.0 mg KOH/g

Acid number=0.05 mg KOH/g

Viscosity (25° C.)=2070 mPas

### Example 3 (Comparison)

### Method Step 1: Propoxylation of Phosphoric Acid:

300.0 g (3.06 mol) of phosphoric acid (100%) were placed in a 2 l stainless steel reactor and heated while stirring to 55° C. After several exchanges between nitrogen and a vacuum between 0.1 and 3.0 bar (absolute), the pressure in the reactor was adjusted to 1.2 bar (absolute) using nitrogen. 1332 g (22.9 mol) of propylene oxide were measured at a temperature of 55° C. within 6 hours. After a secondary reaction time of 5 hours, the reaction mixture was cooled to room temperature and removed from the reactor. Volatile components were distilled out at 90° C. under reduced pressure (approx. 10 mbar) within 30 minutes.

The product had an OH number of 355 mg KOH/g and an acid number of 0.0 mg KOH/g.

Method Step 2: DMC Catalysed Alkoxylation of the Product from Method Step 1:

203 g of the intermediate product from method step 1 and 0.15 g of DMC catalyst were placed in a 2 l stainless steel reactor and heated while stirring (800 rpm) to 130° C. After 45 minutes of nitrogen stripping at a reduced pressure (0.1 bar absolute), 25 g of propylene oxide were added to activate catalysis. After an induction phase of approx. 60 min, the remaining propylene oxide (1272 g) was added continuously to the reactor while stirring (800 rpm) at a temperature of 130° C. within 125 min, wherein the pressure rose to 4.38 bar (absolute) to the end of the addition. After a secondary reaction time of 60 min at 130° C., volatile compounds were distilled out at 90° C. and a reduced pressure (approx. 10 mbar) within 30 minutes. The end product was stabilised with 500 ppm of the antioxidant Irganox 1076.

### Product Properties:

OH number=46.9 mg KOH/g

Viscosity (25° C.)=1155 mPas

### Example 4 (Comparison)

110 g of an ethoxylate (OH number=307 mg KOH/g), produced by KOH catalysis with glycerine as a trifunctional starter, and 0.07 g of DMC catalyst were placed in a 1 l stainless steel reactor and heated while stirring (800 rpm) to 130° C. After 45 minutes of nitrogen stripping at a reduced pressure (0.1 bar absolute), 594 g of propylene oxide were added continuously to the reactor while stirring (800 rpm) at a temperature of 130° C. within 180 min. After a secondary reaction time of 60 min at 130° C., volatile compounds were distilled out at 90° C. and a reduced pressure (approx. 10 mbar) within 30 minutes. The end product was stabilised with 500 ppm of the antioxidant Irganox 1076.

### Product Properties:

OH number=48.7 mg KOH/g

Viscosity (25° C.)=649 mPas

### Example 5 (Comparison)

110 g of an ethoxylate (OH number=307 mg KOH/g), produced by KOH catalysis with glycerine as a trifunctional starter, and 0.07 g of DMC catalyst were placed in a 1 l stainless steel reactor and heated while stirring (800 rpm) to 130° C. After 45 minutes of nitrogen stripping at a reduced pressure (0.1 bar absolute), a mixture of 534 g of propylene oxide and 59 g of ethylene oxide was added continuously to the reactor while stirring (800 rpm) at a temperature of 130° C. within 180 min. After a secondary reaction time of 60 min at 130° C., volatile compounds were distilled out at 90° C. and a reduced pressure (approx. 10 mbar) within 30 minutes. The end product was stabilised with 500 ppm of the antioxidant Irganox® 1076.

### Product Properties:

OH number=48.0 mg KOH/g

Viscosity (25° C.)=657 mPas

TABLE 1
Structures and properties of the produced polyether
polyols (according to the invention and comparison)

| | | Epoxide in | OH | Acid | |
|---|---|---|---|---|---|
| | Intermediate | DMC stage | number | number | Visc. |
| | product from | (method | [mg | [mg | 25° C. |
| | method step 1 | step 2) | KOH/g] | KOH/g] | [mPas] |
| Polyol | | | | | |
| example | | | | | |
| 1 | H₃PO₄ [symbol] EO, OH | PO | 47.3 | 0.09 | 1825 |
| | number 308 | | | | |
| 2 | H₃PO₄ [symbol] EO, OH | PO/EO | 47.0 | 0.05 | 2070 |
| | number 308 | (90/10) | | | |
| Compar- | | | | | |
| ative | | | | | |
| examples | | | | | |
| 3 | H₃PO₄ [symbol] PO, OH | PO | 46.9 | n.d. * | 1155 |
| | number 355 | | | | |
| 4 | GLY [symbol] EO, OH | PO | 48.7 | n.d. * | 649 |
| | number 307 | | | | |
| 5 | GLY [symbol] EO, OH | PO/EO | 48.0 | n.d. * | 657 |
| | number 307 | (90/10) | | | |

* n.d.: not determined

### Formulations for Flexible Polyurethane Foam (Block Foam)

Polyurethane foams were produced according to the formulations listed in Tables 2 and 3 following.

The flammability behaviour was measured in accordance with the standard FMVSS 302, wherein the measured combustion speed (mm s⁻¹) is the determining parameter.

The inventive phosphoric acid-started polyether polyols of examples 1 and 2 result in mixtures which display the same foamability as a pure mixture based on Arcol® 1108, but, with regard to the foam, display a significantly improved flammability behaviour according to the standard FMVSS 302 than foams based on the standard polyol. This is substantiated by the significantly reduced combustion speed of the inventive foams (Table 2, last line, each one an average of 5 measurements).

TABLE 2
Foam formulations and test results

| | | Example | | | | | | |
|---|---|---|---|---|---|---|---|---|
| | | 7 | | | | | | |
| | | Standard | 8 | 9 | 10 | 11 | 12 | 13 |
| Polyol | | | | | | | | |
| Arcol ® 1108 | [p.b.w.] | 100 | 50 | | 50 | 50 | | |
| From ex. 1 | [p.b.w.] | | 50 | 100 | | | | |
| From ex. 2 | [p.b.w.] | | | | | 50 | | 100 |
| Water | [p.b.w.] | 3.0 | 3.0 | 3.0 | 3.0 | 3.0 | 3.0 | 3.0 |
| Niax ® Catalyst A-1 | [p.b.w.] | 0.15 | 0.15 | 0.15 | 0.15 | 0.15 | 0.15 | 0.15 |
| Tegostab ® B 8239 | [p.b.w.] | 1.0 | 1.0 | 1.0 | 1.0 | 1.0 | 1.0 | 1.0 |
| Dabco ® T-9 | [p.b.w.] | 0.18 | 0.18 | 0.18 | 0.18 | 0.18 | 0.18 | 0.18 |
| Desmodur ® T 80 | [p.b.w.] | 39.4 | 39.3 | 39.3 | 39.7 | 39.3 | 40.0 | 39.2 |
| Isocyanate Index | | 108 | 108 | 108 | 108 | 108 | 108 | 108 |
| Bulk density | [kg m⁻³] | 31.4 | 32.6 | 30.6 | 31.5 | 32.9 | 32.0 | 33.2 |
| Compressive | [kPa] | 4.2 | 4.2 | 3.6 | 3.4 | 4.0 | 3.5 | 3.6 |
| hardness 40% | | | | | | | | |
| FMVSS 302 | | | | | | | | |
| Combustion speed | [mm s⁻¹] | 94 | 27 | 9 | 49 | 0 | 0 | 0 |

TABLE 3
Foam formulations and test results

| | | Example | | | | | |
|---|---|---|---|---|---|---|---|
| | | 14 | | | | | |
| | | Standard | 15 | 16 | 17 | 18 | 19 |
| Polyol | | | | | | | |
| Arcol ® 1108 | [p.b.w.] | 100 | 50 | | 50 | | |
| From ex. 4 (compare) | [p.b.w.] | | 50 | 100 | | | |
| From ex. 5 (compare) | [p.b.w.] | | | | 50 | 100 | |
| From ex. 3 (compare) | [p.b.w.] | | | | | | 100 |
| Water | [p.b.w.] | 3.0 | 3.0 | 3.0 | 3.0 | 3.0 | 3.0 |
| Niax ® Catalyst A-1 | [p.b.w.] | 0.15 | 0.15 | 0.15 | 0.15 | 0.15 | 0.15 |
| Tegostab ® B 8239 | [p.b.w.] | 1.0 | 1.0 | 1.0 | 1.0 | 1.0 | 1.0 |
| Dabco ® T-9 | [p.b.w.] | 0.18 | 0.18 | 0.18 | 0.18 | 0.18 | 0.18 |
| Desmodur ® T 80 | [p.b.w.] | 39.4 | 39.4 | 39.4 | 39.4 | 39.4 | 39.4 |
| Isocyanate Index | | 108 | 108 | 108 | 108 | 108 | 108 |
| Bulk density | [kgm⁻³] | 31.4 | 31.4 | 30.7 | 29.3 | 34.6 | 46.2 |
| Compressive | [kPa] | 4.2 | 4.6 | 4.2 | 4.8 | 4.9 | 4.2 |
| hardness 40% | | | | | | | |
| FMVSS 302 | | | | | | | |
| Combustion speed | [mm s⁻¹] | 94 | 91 | 84 | 90 | 84 | 29 |

Foams based on the comparative polyols from examples 4 and 5, which were started on glycerine, display no better flammability behaviour compared with foams based on the standard polyol Arcol 1108 (cf Table 3).

The polyol based on pure propylene oxide from the comparative example 3 does not permit a stable foaming process as can be seen from the significantly higher foam density (46 kg/m³). Thus, it is not possible to compare their flammability behaviour.

1. A method for producing poly(oxyalkylene) polyols, comprising initially in a first step
(i) reacting
A) a hydroxyl functional component comprising
i) at least one phosphorus-containing compound with at least one hydroxyl group,
or
ii) a mixture of at least one phosphorus-containing compound having at least one hydroxyl group with at least one H-functional starter compound, wherein the proportion of the H-functional starter compounds in the mixture is no more than 50% w/w,
with
B) an alkylene oxide component comprising:
i) ≥50 to ≤100% w/w of ethylene oxide,
and
ii) ≥0 to ≤50% w/w of other alkylene oxides,
to form a product:
(II) reacting the product obtained from the first step in the presence of a DMC catalyst, with
C) an alkylene oxide component, comprising:
i) ≥0 to ≤25% w/w of ethylene oxide
and
ii) ≥75 to ≤100% w/w of other alkylene oxides and, optionally,
D) carbon dioxide
wherein in step (I), the molar ratio of component (B) to hydroxyl groups of component (A) ranges from 1:1 to 8:1.

2. The method in accordance with claim 1, wherein, component A)i) said phosphorus-containing compound with at least one hydroxyl group comprises
a) a compound corresponding to the formula: 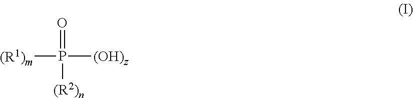
wherein:
z represents a whole number from 1 to 3,
n represents 0 or 1,
m represents 0 or 1
and
the sum of z+m+n=3,
and
R¹ and R² may be the same or differ from each other and each represents
i) —H
ii) —P(O)(OH)₂
iii) saturated or unsaturated, linear or branched, aliphatic or cycloaliphatic or optionally, substituted aromatic or araliphatic residuals with up to 10 carbon atoms linked to the phosphorus via a C atom, which optionally contain heteroatoms from the series oxygen, sulphur and nitrogen,
iv) —OR³ or —OC(O) R⁴, wherein R³ or R⁴ may be the same or different and each represents saturated or unsaturated, linear or branched, aliphatic or cycloaliphatic or optionally, substituted aromatic or araliphatic residuals with up to 10 carbon atoms, which optionally contain heteroatoms from the series oxygen, sulphur and nitrogen,
and/or
b) oligomers and/or polymers of any of the compounds listed in a) having at least one hydroxyl group and obtainable by condensation are used, wherein condensates comprise one compound or mixtures of condensates, and the resultant oligomers or polymers can have linear, branched or ring-shaped structures.

3. The method according to claim 2, wherein a) said compounds corresponding to formula (I) comprise phosphoric acid, phosphonic acid (phosphorous acids), phosphinic acid, pyrophosphoric acid (diphosphoric acid), diphosphonic acid, polyphosphoric acid, polyphosphonic acid, triphosphoric acid, phosphonic acid, tetrapolyphosphoric acid or tetrapolyphosphonic acid, trimetaphosphoric acid, tetrametaphosphoric acid, hypodiphosphoric acid, esters of any of these compounds, and combinations thereof.

4. The method according to claim 1, wherein component A) comprises A)i) 100 percent phosphoric acid, or A)ii) a mixture of 85 percent phosphoric acid and at least one other H-functional starter compound.

5. The method according to claim 1, wherein component B)i) comprises ≥80% w/w of ethylene oxide.

6. The method according to claim 1, wherein, in step (I), the molar ratio of component (B) to the hydroxyl groups of component (A) ranges from 2:1 to 5:1.

7. The method according to claim 1, wherein step (I) is performed
i) without a catalyst to catalyze the alkoxylation reaction, or
ii) in the presence of a catalyst to catalyze the alkoxylation reaction, in which the catalyst is not a DMC catalyst.

8. The method according to claim 1, wherein component C)ii) comprises ≥85% w/w of other alkylene oxides in step (II).

9. The method according to claim 1, wherein component B) ii) and/or component C) ii) independently from each other comprise propylene oxide, 1-butene oxide, 2,3-butene oxide, 2-methyl-1,2-propene oxide(isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidised fats as mono-, di- and triglycerides, epoxidised fatty acids, C₁-C₂₄ esters of epoxidised fatty acids, epichlorhydrin, glycidol, and derivates of the glycidols, such as methyl glycidyl ether, ethyl glycidyl ether, 2-ethyl hexyl glycidyl ether, allyl glycidyl ether, glycidyl methacrylate and epoxy-functional alkoxysilanes, such as 3-glycidyloxypropyltrimethoxysilane, 3-glycidyloxypropyltriethoxysilane, 3-glycidyloxypropyltripropoxysilane, 3-glycidyloxypropyl-methyl-dimethoxysilane, 3-glycidyloxypropylethyldiethoxysilane, 3-glycidyloxy-propyltrilisopropoxysilane, or combinations thereof.

10. The method according to claim 1, wherein in step (II) the molar ratio of component C) to hydroxyl groups of the product from step (I) ranges from 5:1 to 30:1.

11. Poly(oxyalkylene) polyols obtainable by a method according to claim 1.

12. A process for producing polyurethane foams comprising reacting an isocyanate component with the poly(oxyalkylene) polyols of claim 11.

13. A method for producing polyurethane foams comprising reacting
E) an isocyanate-reactive component comprising E)1) at least one poly(oxyalkylene) polyol according to claim 11,
F) optionally one or more of
F1) catalysts
and/or
F2) auxiliary materials and additives,
G) water and/or physical propellants,
with
H) di and/or polyisocyanates,
wherein the reaction occurs at an isocyanate index from ≥90 to ≤120.

14. A method for producing polyurethane foams, according to claim 13, wherein E) comprises
E)1) ≥20 to ≤100 parts by weight of at least one poly(oxyalkylene) polyol according to claim 11, and having hydroxyl values as measured in accordance with DIN 53240 of from ≥20 mg KOH/g to ≤130 mg KOH/g,
E)2) ≤80 to ≥0 parts by weight of at least one poly(oxyalkylene) polyol which has hydroxyl values as measured in accordance with DIN 53240 of from ≥20 mg KOH/g to ≤130 mg KOH/g and does not fall under the definition of component E)1),
and
E)3) ≤50 to ≥0 parts by weight, in relation to the total of the parts by weight of the components E)1), and E)2), of at least one compound having groups reactive with isocyanates, which does not fall under the definition of components E)1) or E)2),
wherein the total of the parts by weight of E)1)+E)2) in the composition produces 100 parts by weight.

15. A method for producing polyurethane foams comprising reacting
component E) which comprises
E)1) at least one poly(oxyalkylene) polyol, according to claim 11
E)2) at least one poly(oxyalkylene) polyol, which was not produced from phosphorus-containing compounds,
F) optionally, one or more of
F1) catalysts
and/or,
F2) auxiliary materials and additives
G) water and/or physical propellants,
with
H) di and/or polyisocyanates,
wherein the reaction occurs at an isocyanate index from ≥90 to ≤120.

16. A method for producing polyurethane foams, according to claim 15, wherein E) comprises
E)1) ≥20 to <100 parts by weight of at least one poly(oxyalkylene) polyols according to claim 11 and has hydroxyl values as measured in accordance with DIN 53240 of from ≥20 mg KOH/g to ≤130 mg KOH/g,
E)2) ≤80 to >0 parts by weight, preferably of at least one poly(oxyalkylene) polyol which has hydroxyl values as measured in accordance with DIN 53240 of from ≥20 mg KOH/g to ≤130 mg KOH/g and which was not produced from phosphorus-containing compounds,
E)3) ≤50 to ≥0 parts by weight, in relation to the total of the parts by weight the components E)1 and E)2), of at least one compound having groups reactive with isocyanates, which does not fall under the definition of components E)1) or E)2,
wherein the total of the parts by weight of E)1)+E2) in the composition produces 100 parts by weight.

17. A polyurethane foam obtainable by a method according to claim 13.

18. An article comprising the polyurethane foam according to claim 17 in furniture, textile inserts, bedding, automotive and/or construction industries.

19. The method according to claim 5, wherein component B)i) comprises ≥90% w/w of ethylene oxide.

20. The method according to claim 8, wherein component C)ii) comprises ≥90% w/w of other alkylene oxides.

21. The method according to claim 10, wherein the molar ratio of component C) to hydroxyl groups of the product from step (I) ranges from 10:1 to 20:1.

22. The method according to claim 1, wherein B)ii) said other alkylene oxides comprise propylene oxide.

23. The method according to claim 1, wherein C)ii) said other alkylene oxides comprise propylene oxide.
